(19) United States
(12) Patent Application Publication
(10) Pub. No.: US 2010/0191875 A1
(43) Pub. Date: Jul. 29, 2010

(54) Communication network and converter module

(75) Inventors: Stefan BEYER, Ebermannsdorf (DE); Harald Gebuhr, Nurnberg (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens AG, Munchen (DE)

(21) Appl. No.: 12/691,497

(22) Filed: Jan. 21, 2010

(30) Foreign Application Priority Data
Jan. 23, 2009 (EP) 09 151 221

(51) Int. Cl. G06F 3/00

(52) U.S. Cl. 710/30

(57) ABSTRACT

A converter module comprising a first connection for connection to a first data line for communication with a superordinate plane, a second connection for connection to a second data line for communication with a subordinate plane having a conversion means for converting a first protocol of the superordinate plane into a second protocol of the subordinate plane, wherein a device for operating safety-oriented communication within the subordinate plane is provided, and wherein the device can be activated by an enabling device.

### BACKGROUND OF THE INVENTION

1. Field of the Invention

The invention relates to network communications and, more particularly, to a communication network having an automation appliance which is associated with a superordinate plane and which is connected to a converter module by a first data line, where the converter module is connected to at least one terminal in a subordinate plane by a second data line. The invention also relates to a converter module having a first connection for connection to a first data line for communication with a superordinate plane, a second connection for connection to a second data line for communication with a subordinate plane, where the communication module also includes a conversion means for converting a first protocol of the superordinate plane into a second protocol of the subordinate plane.

2. Description of the Related Art

Automation engineering involves the use of industrial communication systems, such as a field bus, Profibus or Profinet, for communication between field devices and superordinate automation systems. By way of example, it is thus possible for a programmable logic controller (PLC) to be connected by a field bus to a distributed peripheral area that accepts process variables and sends these process variables to the programmable logic controller.

When transferring from a first communication plane for an industrial process to a second communication plane for the industrial process, however, the need may arise to change from one field bus system to another field bus system. This change is implemented using converter modules or using communication networks that are designed to implement the change and which contain the different field bus systems.

The situation may also arise in automation engineering in which safety-relevant processes need to be automated and hence safety-oriented components need to be used for this. However, it may thus arise in the different planes of the field bus systems that, by way of example, safety-oriented appliances are used in the first plane and hence also a communication protocol which is oriented to provide safety functions is operated in the first plane. In the second plane, on the other hand, terminals are connected to the first plane by a converter module. However, these terminals are not necessarily located in a safety zone and accordingly do not need to be safety-oriented. Consequently, it is also not necessary to operate a safety protocol in the second plane, and the converter module is accordingly not oriented to safety engineering. If the conditions of production change and this change requires safety engineering, however, then the converter module needs to be replaced with a converter module with safety engineering and the installation needs to be reconfigured.

### SUMMARY OF THE INVENTION

It is therefore an object of the invention to provide a communication network which allows operation with a safety-oriented terminal and simplifies planning for a planner of such an installation.

This and other objects and advantages are achieved for the communication network in accordance with the invention by providing a converter module having a means for operating safety-oriented communication within the subordinate plane, where the means can be activated by an enabling means. In an exemplary embodiment, the converter module is a converter module for an input/output (I/O) link, where the I/O link can comprise an I/O master to which 10 slaves are connected. In preferred embodiments, the I/O slaves are subdivided into actuators and sensors, i.e., terminals which either accept input variables or provide output variables. In addition, the terminals are dividable into standard terminals and safety terminals.

When standard terminals are connected to the converter module in the form of an I/O master, the use of the communication network requires no additional steps. If a safety terminal is connected to the converter module, however, then the communication grouping of the communication network also requires the connection from the converter module to the terminal to be safety-oriented. Here, it is particularly advantageous that the converter module activates the means for operating safety-oriented communication by the enabling means which resorts to the presence of a connected safety terminal to implement the activation. Preferably, the superordinate plane comprises a safety-oriented communication plane. Here, for example, this involves a programmable logic controller (PLC) using a Profibus, which is provided with the Profi-Save functionality, in order to communicate with a safety-oriented first protocol by a first data line to the converter module. The converter module is now prepared for continuous safety-oriented communication by virtue of the activated means for operating safety-oriented communication. Consequently, it is possible for safety-oriented communication from the superordinate plane to the subordinate plane to occur right up to the terminals.

Preferably, the terminal includes a descriptor element which can be read by the enabling means. This descriptor element preferably contains a code sequence, check digit, enabling license, safety level or a criterion for use. The reading of the descriptor element by the enabling means that is arranged within the converter module allows the converter module to automatically adjust to a respectively required safety level.

In a preferred embodiment, the second data line comprises a 3-wire line. In this case, communication for an I/O link over a data line, such as a 3-wire line, is a minimum. In an alternative embodiment, two optional additional lines are added. In this case, an appropriate plug contact for an I/O link data line would therefore have five contacts or five pins.

The object of the contemplated embodiments is also achieved by a converter module that includes a means for operating safety-oriented communication within the subordinate plane, where the means can be activated by an enabling means. In preferred embodiments, the converter module is used as an I/O master, where the enabling means are used to implement activation of a safety protocol.

In an advantageous embodiment, the means is produced with memory means for a segment of safety-oriented software. Here, the converter module contains a segment of system software which controls the functional processes to ensure the proper functionality within the converter module. In accordance with the contemplated embodiments, this system software comprises firmware. The converter module thus advantageously includes memory means for a segment of safety-oriented software, which memory means provides a segment of firmware for a safety-oriented converter module.

In another advantageous embodiment, the enabling means is configured such that a descriptor element of a connected terminal can be read. In accordance with the contemplated embodiment, the converter module can be changed over or controlled based on the information read from the descriptor element by the enabling means in line with the functionality which it needs to perform. Here, if a safety terminal is connected instead of a standard terminal, the enabling means ensures that the means for operating safety-oriented communication between converter module and terminal are activated.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Further advantages and refined features can be found in the drawing, in which:

FIG. 1 shows a communication network with a first and a second communication plane in accordance with an embodiment of the invention; and

FIG. 2 shows a converter module with a connected terminal of FIG. 1.

### DETAILED DESCRIPTION OF THE PRESENTLY PREFERRED EMBODIMENTS

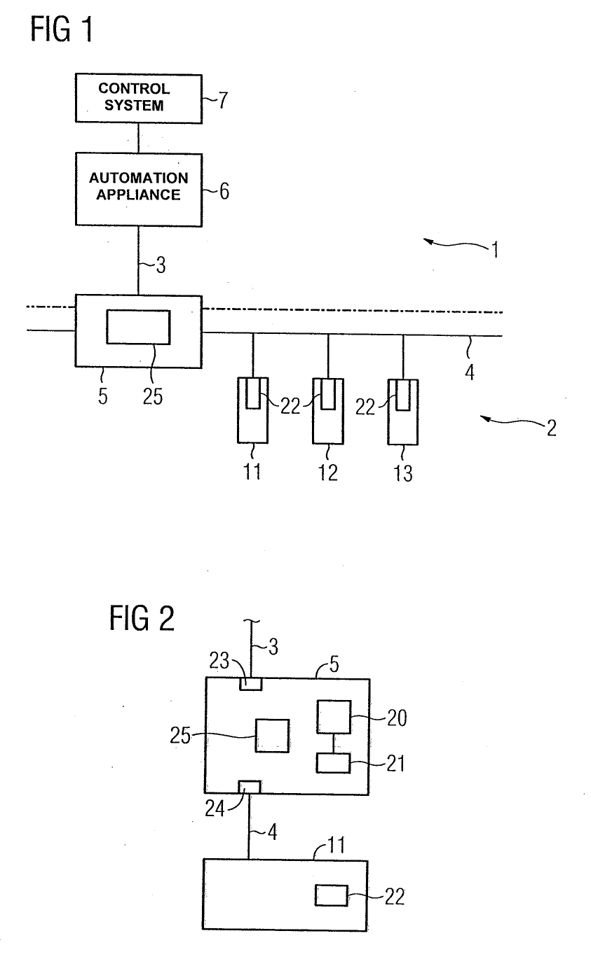

As shown in FIG. 1, a control system 7 is connected to an automation appliance 6 by a bus system. The automation appliance 6 comprises a programmable logic controller (PLC) configured to provide safety functions. The automation appliance 6 is connected to a converter module 5 by a first data line 3. In accordance with the invention, the control system 7 and the automation appliance 6 define a first communication plane or superordinate plane 1, where isolation between the first communication plane 1 and a second communication plane or a subordinate plane 2 is indicated by a dot-dashed line. In the first communication plane 1, a first protocol is used for data interchange between the communication subscribers arranged in the first communication plane 1. In the second communication plane 2, a second protocol is used for data interchange between the communication subscribers arranged in the second communication plane 2.

The converter module 5 preferably exhibits the functionality of an interface and to this end is configured to use a conversion means 25 to convert the first protocol into the second protocol and to use the conversion means 25 to convert the second protocol into the first protocol. The converter module 5 includes a first terminal 11, a second terminal 12 and a third terminal 13 that are connected to the converter module 5 by a second data line 4. Here, the first terminal 11 is configured as a sensor that measures the temperature within a chemical critical process. In accordance with the invention, the second terminal 12 and the third terminal 13 comprise actuators for the purpose of activating safety measures. Such sensors/actuators are provided in diversitary form for safety-oriented installations.

FIG. 2 shows a detailed illustration of the converter module 5 of FIG. 1 connected to the first terminal 11. Here, the converter module 5 has a first connection 23 for connection to the first data line 3 for providing communication between the converter module 5 and the superordinate plane 1. In addition, a second connection 24 is provided for connection to a second data line 4 for providing communication with the subordinate plane 2. The conversion means 25 comprises a protocol and signal converter for converting the first protocol that is used in the first plane 1 into the second protocol that is used in the second plane 3. In addition, a means 20 for operating safety-oriented communication is used to adjust the functionality of the converter module 5 for operating safety-oriented communication within the subordinate plane 2. Here, the means 20 can be activated by an enabling means 21 that is configured to read an identification feature from a descriptor element 22 of the first terminal 11 through the second connection 24 using the second data line 4. The identification feature is evaluated in the enabling means 21 and adjusts the converter module 5 to suit the safety conditions needed or demanded for the operation of safety-oriented terminals 11, 12, 13.

The contemplated embodiments of the invention are advantageous in that standard terminals and safety terminals can be connected to a converter module. Consequently, it is now possible to carry only one variant in storage. In addition, the descriptor elements in the safety terminals can contain a license key, where the license keys in turn release a lock stored in the converter module, so that the converter module releases its functionality with added value only if a terminal with a license key is connected. Moreover, mistaken incorporation of standard terminals in a safety loop can be detected by the converter module, and a safety-influencing message can be used to react to the mistaken incorporation of the standard terminals in the safety loop. As a result, an unsuitable terminal is prevented from being mistakenly used in a repair situation.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A communication network, comprising:
a converter module;
an automation appliance associated with a superordinate plane and connected to the converter module by a first data line; and
at least one terminal in a second subordinate plane connected to the converter module by a second data line;
wherein the converter module includes operating means for operating safety-oriented communication within the second subordinate plane, and enabling means for activating the operating means.

2. The communication network as claimed in claim 1, wherein the at least one terminal includes a descriptor element which is readable by the enabling means.

3. The communication network as claimed in claim 1, wherein the second data line comprises a three-wire line.

4. The communication network as claimed in claim 2, wherein the second data line comprises a three-wire line.

5. The communication network as claimed in claim 1, wherein the converter module comprises an input/output (I/O) link master and the at least one terminal comprises an I/O link slave.

6. The communication network as claimed in claim 2, wherein the converter module comprises an input/output (I/O) link master and the at least one terminal comprises an I/O link slave.

7. The communication network as claimed in claim 3, wherein the converter module comprises an input/output (I/O) link master and the at least one terminal comprises an I/O link slave.

8. A converter module comprising:
a first connection for connection to a first data line for communication with a superordinate plane;
a second connection for connection to a second data line for communication with a second subordinate plane;
a conversion means for converting a first protocol of the first superordinate plane into a second protocol of the second subordinate plane; and
operating means for operating safety-oriented communication within the second subordinate plane;
enabling means for activating the operating means.

9. The converter module as claimed in claim 8, wherein the operating means comprises memory means for storing safety-oriented software.

10. The converter module as claimed in claim 8, wherein the enabling means is configured to read a descriptor element of a connected terminal.

11. The converter module as claimed in claim 9, wherein the enabling means is configured to read a descriptor element of a connected terminal.

12. The converter module as claimed in claim 10, wherein the descriptor element includes an identification feature indicating safety conditions required for operation of the connected terminal.
